(19) United States
(12) Patent Application Publication
(10) Pub. No.: US 2015/0124871 A1
(43) Pub. Date: May 7, 2015

(54) Visual Perceptual Transform Coding of Images and Videos

(71) Applicant: Mitsubishi Electric Research Laboratories, Inc., Cambridge, MA (US)

(72) Inventors: Robert A. Cohen, Somerville, MA (US); Velibor Adzic, Boca Raton, FL (US); Anthony Vetro, Arlington, MA (US)

(73) Assignee: Mitsubishi Electric Research Laboratories, Inc., Cambridge, MA (US)

(21) Appl. No.: 14/073,311

(22) Filed: Nov. 6, 2013

(51) Int. Cl. H04N 19/159; H04N 19/18; H04N 19/126; H04N 19/13; H04N 19/583

(52) U.S. Cl. CPC H04N 19/00218; H04N 19/00121; H04N 19/00733; H04N 19/00096; H04N 19/00296
USPC 375/240.03

(57) ABSTRACT

A method decodes a picture that is encoded and represented by blocks in a bitstream, by first determining, from the bitstream, motion associated with the block. Using a model, the motion is mapped to indices indicating a subset of quantized transform coefficients to be decoded from the bitstream. Then, values are assigned and reinserted to the quantized transform coefficients not in the subset.

### FIELD OF THE INVENTION

This invention relates generally to video coding, and more particularly to modifying the signaling of transform coefficients based upon perceptual characteristics of the video content.

### BACKGROUND OF THE INVENTION

When videos, images, multimedia or other similar data are encoded or decoded, compression is typically achieved by quantizing the data. A set of previously reconstructed blocks of data is used to predict the block currently being encoded or decoded. The set can include one or more previously reconstructed blocks. A difference between a prediction block and the block currently being encoded is a prediction residual block. In the decoder, the prediction residual block is added to a prediction block to form a decoded or reconstructed block.

FIG. 1 shows a decoder according to conventional video compression standards, such as High Efficiency Video Coding (HEVC). Previously reconstructed blocks 150, typically stored in a memory buffer are fed to a motion-compensated prediction process 160 or to an intra prediction process 170 to generate a prediction block 132. The decoder parses and decodes 110 a bitstream 101. The motion-compensated prediction process uses motion information 161 decoded from the bit-stream, and the intra prediction process uses intra mode information 171 decoded from the bit-stream. Quantized transform coefficients 122 decoded from the bitstream are inverse quantized 120 to produce reconstructed transform coefficients 121, which in turn are inverse transformed 130 to produce a reconstructed prediction residual block 131. The pixels in the prediction block 132 are added 140 to those in the reconstructed prediction residual block 131 to obtain a reconstructed block 141 for the output video 102, and the set of previously reconstructed block 150 are stored in a memory buffer.

FIG. 2 shows an encoder according to conventional video compression standards, such as HEVC. A video or a block of input video 201 is input to a motion estimation and motion-compensated prediction process in inter-mode. The prediction portion of this process 205 uses previously-reconstructed blocks 206, typically stored in a memory buffer, to generate a prediction block 208 corresponding to the current input video block along with motion information 209 such as motion vectors.

Alternatively in intra-mode, the prediction block can be determined by an intra prediction process 210, which also produces intra mode information 211. The input video block and the prediction block are input to a difference calculation 214, which outputs a prediction residual block 215. This prediction residual block is transformed 216, the produce transform coefficients 219, and quantized 217, using rate control 213, which produces quantized transform coefficients 218. These coefficients are input to an entropy coder 220 for signaling in a bitstream 221. Additional mode and motion information are also signaled in the bitstream.

The quantized transform coefficients also undergo an inverse quantization 230 and inverse transform process 240, which in turn is added 250 to the prediction block to produce a reconstructed block 241. The reconstructed block is stored in memory for use in subsequent prediction and motion estimation processes.

Compression of data is primarily achieved through the quantization process. Typically, the rate control module 213 determines quantization parameters that control how coarsely or finely a transform coefficient is quantized. To achieve lower bitrates or small file sizes, transform coefficients are quantized more coarsely, resulting in fewer bits output to the bitstream. This quantization introduces both visual and numerical distortion into the decoded video, as compared to the video input to the encoder. The bitrate and measured distortion are typically combined in a cost function. The rate control chooses parameters, which minimize the cost function, i.e., minimizes the bitrate needed to achieve a desired distortion or minimizing distortion associated with a desired bitrate. The most common distortion metrics are determined using a mean squared error (MSE) or mean absolute error, which are typically determined by taking pixel-wise differences between blocks and reconstructed versions of the blocks.

Metrics such as MSE, however, do not always accurately reflect how the human visual system (HVS) perceives distortion in images or video. Two decoded images having the same MSE as compared to the input image may be perceived by the HVS as having significantly different levels of distortion, depending upon where the distortion is located in the image. For example, the HVS is more sensitive to noise in smooth regions of an image as compared to having noise in highly textured areas. Moreover, the visual acuity, which is the highest spatial frequency that can be perceived by the HVC, is dependent upon the motion of the object or scene across the retina of the viewer. For a normal visual acuity the highest spatial frequency that can be resolved is 30 cycles per degree of visual angle. This value is calculated for a visual stimulus that is stationary on the retina. The HVS is equipped with a mechanism of eye movements that enables tracking of a moving stimulus, keeping it stationary on the retina. However, as the velocity of the moving stimulus increases, the tracking performance of the HVS declines. This results in a decrease of a maximum perceptible spatial frequency. The maximum perceptible spatial frequency can be expressed as the following function:

$${K}_{x / y} = \frac{{K}_{max} \cdot {v}_{c}}{{v}_{{R}_{x / y}} + {v}_{c}}$$

where Kₘₐₓ is the highest perceptible frequency for a static stimulus (30 cycles per degree), v_{Rx/y} is velocity component of stimulus in horizontal or vertical direction, and v_{c} is Kelly's corner velocity (2 degrees per second). This function is shown in FIG. 6. As can be seen, the decrease in maximum perceptible frequency can be significant, depending upon the retinal velocity. All frequencies above the maximum value cannot be perceived by humans.

Prior art methods related to using perceptual metrics to code images and video typically replace or extend the distortion metric in the rate-control cost function with perceptually motivated distortion metrics, which are designed based upon the behavior of the HVS. One method use a visual attention model, just-noticeable-difference (JND), contrast sensitivity function (CSF), and skin detection to modify how quantization parameters are selected in an H.264/MPEG-4 Part 10 codec. Transform coefficients are quantized more coarsely or finely based in part on these perceptual metrics. Another method uses perceptual metrics to normalize transform coefficients. Because these existing methods for perceptual coding are essentially forms of rate control and coefficient scaling, the decoder and encoder must still be capable of decoding all transform coefficients at any time, including transform coefficients that represent spatial frequencies that are not visible to the HVS due to the motion of a block. The coefficients that fall into this category unnecessarily consume bits in the bitstream and require processing that adds little or no quality to the decoded video.

There is a need, therefore, for a method to eliminate the signaling of coefficients that do not add to the perceptual quality of the video and eliminates the additional software or hardware complexity associated with receiving and processing those coefficients.

### SUMMARY OF THE INVENTION

Embodiments of the invention are based on a realization that various encoding/decoding (codec) techniques must be capable of processing and signaling coefficients that represent spatial frequencies that are not perceptible to a viewer.

This invention uses a motion-based visual acuity model to determine what frequencies are not visible, and then instead of only quantizing the corresponding coefficients more coarsely as done in traditional rate control methods, the invention eliminates the need to signal or decode those coefficients. The elimination of those coefficients further reduces the amount of data that need to be signaled in the bitstream, and reduces the amount of processing or hardware needed to decode the data.

### BRIEF DESCRIPTION OF THE DRAWINGS

FIG. 1 is a schematic of a decoder according to the prior art;

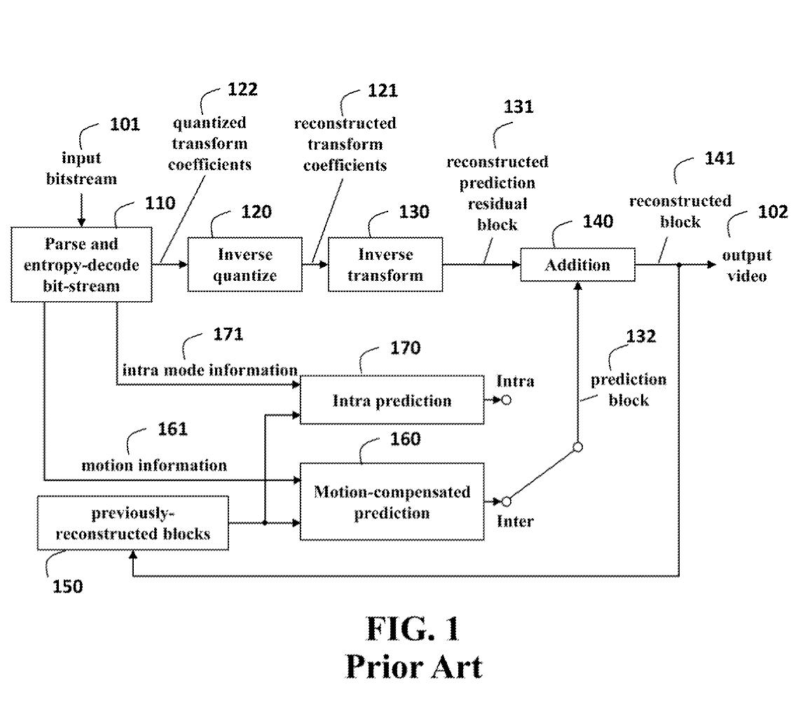

FIG. 2 is a schematic of an encoder according to the prior art; and

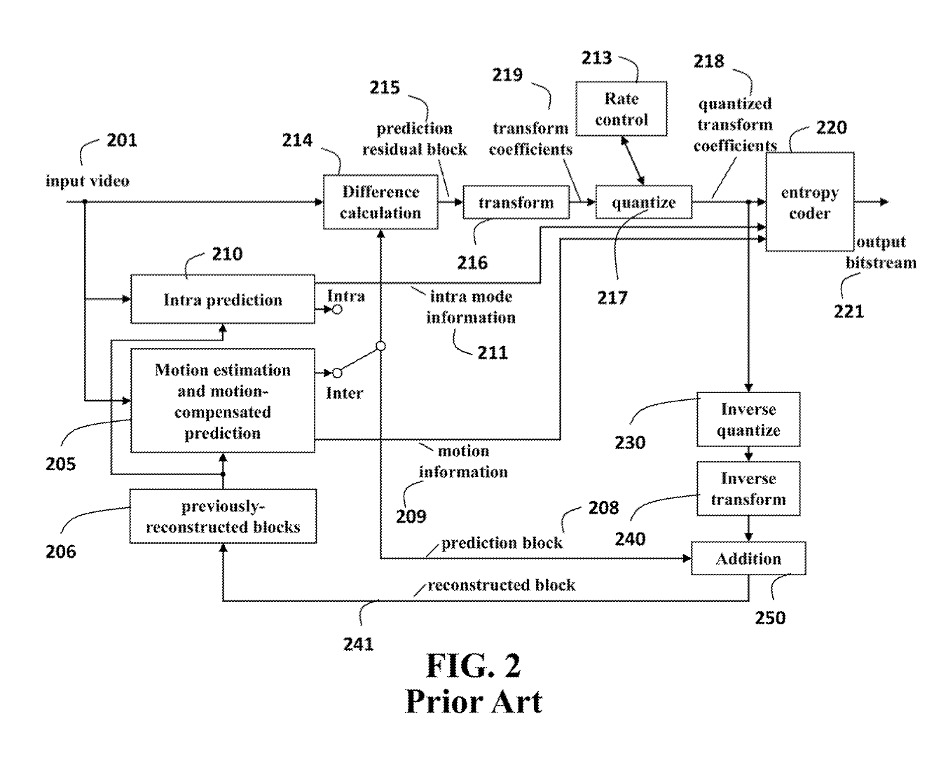

FIG. 3 is a schematic of a decoder according to embodiments of the invention;

FIG. 4 is a schematic of a visual perceptual model, spatiotemporal coefficient selector, and coefficient reinsertion according to embodiments of the invention;

FIG. 5 is a diagram of the steps of identifying motion, determining cutoff indices, and determining which coefficients are signaled;

FIG. 6 is an illustration of a perceptual model relating spatial perceptual characteristics to motion velocity according to the prior art; and

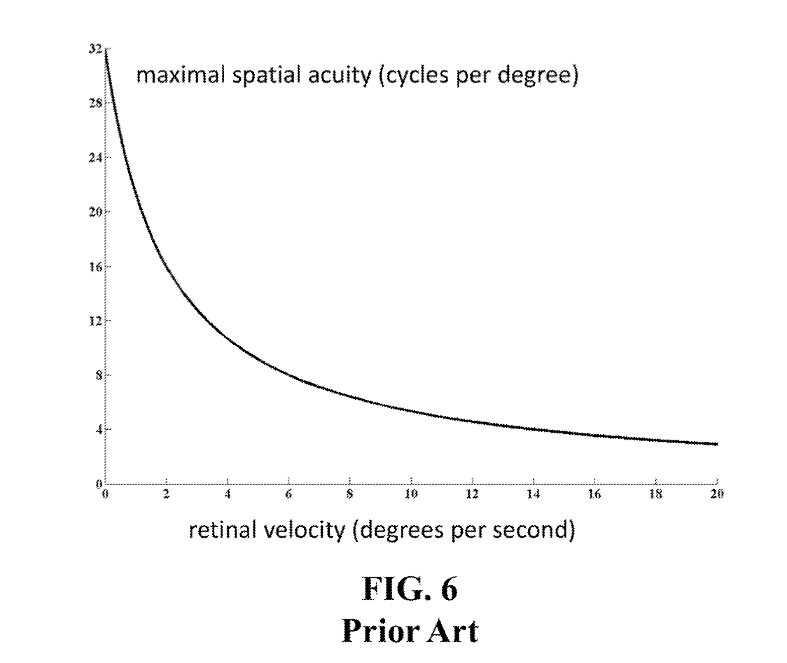

FIG. 7 is a schematic of an encoder according to embodiments of the invention.

### DETAILED DESCRIPTION OF THE PREFERRED EMBODIMENTS

### Decoder

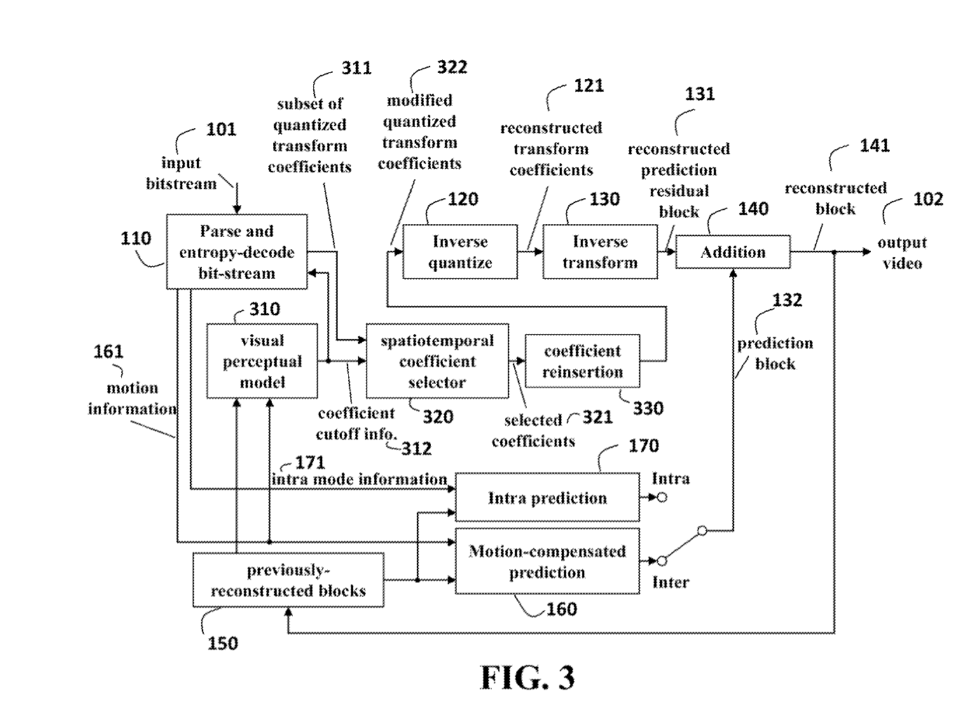

FIG. 3 shows a schematic of a decoder according to the embodiments of the invention. Previously reconstructed blocks 150, typically stored in a memory buffer are fed to a motion-compensated prediction process 160 or to an intra prediction process 170 to generate a prediction block 132. The decoder parses and decodes 110 a bitstream 101. The motion-compensated prediction process uses motion information 161 decoded from the bit-stream, and the intra prediction process uses intra mode information 171 decoded from the bit-stream.

The motion information 161 is also input to a visual perceptual model 310. The visual perceptual model first estimates the velocity of a block or object represented by the block. The “velocity” is characterized by changes in pixel intensities, which can be represented by a motion vector. A formula, which incorporates a visual acuity model and the velocity, identifies a range of spatial frequency components that are not likely to be detected by the human visual system. The visual perceptual model can also incorporate the content of neighboring previously-reconstructed blocks when determining the range of spatial frequencies. The visual perceptual model then maps the spatial frequency range to a subset of transform coefficient indices. Transform coefficients that are outside this subset represent spatial frequencies that are imperceptible, based on the visual perceptual model. Horizontal and vertical indices representing the boundaries of the subset are signaled as coefficient cutoff information 312 to a spatiotemporal coefficient selector 320.

A subset of quantized transform coefficients 311 is decoded from the bitstream and is input to the spatiotemporal coefficient selector. Given the coefficient cutoff information, the spatiotemporal coefficient selector arranges the subset of quantized transform coefficients according to the positions determined by the visual perceptual model. These arranged selected coefficients 321 are input to a coefficient reinsertion process 330, which substitutes predetermined values, e.g., zero, into the positions corresponding to coefficients which were cut off, i.e., not part of the subset identified by the visual perceptual model.

After coefficient reinsertion, the resulting modified quantized transform coefficients 322 are inverse quantized 120 to produce reconstructed transform coefficients 121, which in turn are inverse transformed 130 to produce a reconstructed prediction residual block 131. The pixels in the prediction block 132 are added 140 to those in the reconstructed prediction residual block 131 to obtain a reconstructed block 141 for the output video 102, and the set of previously reconstructed block 150 are stored in a memory buffer.

Perceptual Model and Coefficient Processing

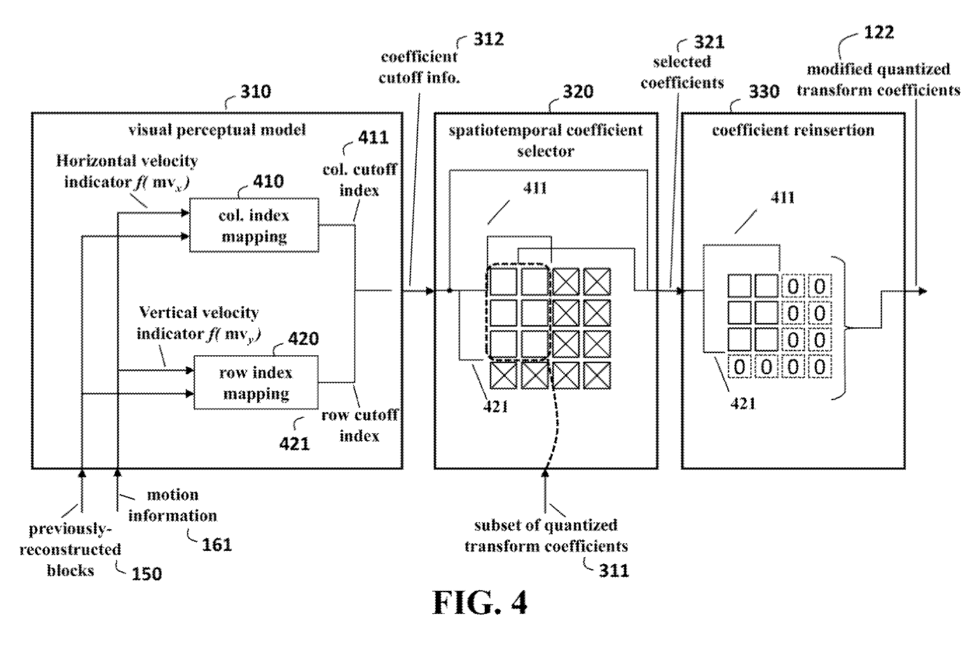

FIG. 4 shows details of the visual perceptual model 310, spatiotemporal coefficient selector 320, and coefficient reinsertion 330 according to embodiments of the invention. Motion information 161 can be, for example, in the form of motion vectors mvₓ and mr_{y}, representing horizontal and vertical motion respectively. The horizontal velocity of the block or object represented by the block is determined as a function ƒ(mvₓ) of the motion vector. Similarly, the vertical velocity is determined as ƒ(mv_{y}). The horizontal velocity is mapped 410 to a column cutoff index 411 based upon the visual perceptual model.

For example, the decoder normally processes an N×N block of transform coefficients. This block has N columns and N rows. If the column cutoff index is cₓ, then the visual perceptual model has determined that horizontal frequencies represented by coefficients in columns 1 through cₓ, are perceptible, and the horizontal frequencies represented by coefficients in columns cₓ through N are imperceptible. Similarly, the vertical velocity ƒ(mv_{y}) is mapped 420 to a row cutoff index c_{y} 421 The column cutoff and row cutoff indices comprise the coefficient cutoff information 312, which is signaled to the spatiotemporal coefficient selector 320.

The subset of quantized transform coefficients 311 decoded from the bitstream form an incomplete set of transformed coefficients, because coefficients that were beyond the row or column cutoff indices were not signaled in the bitstream. The coefficient cutoff information is used to arrange the subset of quantized transform coefficients. These selected coefficients 321 are then input a coefficient reinsertion process, which fills in values for the missing coefficients. Typically, a value of zero is used for this substitution. In the example above, and in the common cases where the transform being used by the codec is related to the Discrete Cosine Transform (DCT), the selected coefficients are a cₓ×c_{y} block of coefficients, which can be placed in the upper-left corner of an N×N block. Positions not occupied by the selected coefficients are filled with zero values. The output of the coefficient reinsertion process is a block of modified quantized transform coefficients 122, which is processed by the rest of the decoder.

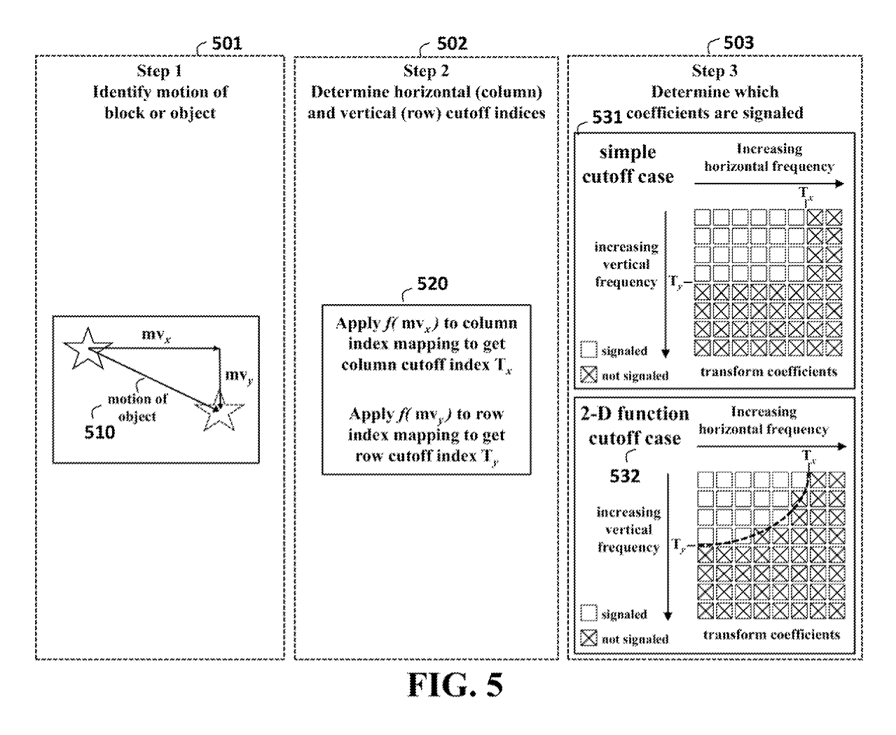

FIG. 5 is a diagram of the steps 501, 502 and 503 of identifying motion, determining cutoff indices, and determining, which coefficients are signaled. Step 1 identifies motion of the block or object. Step 2 determines horizontal (column) and vertical (row) cutoff indices. Step 3 determines the coefficients that are signaled.

As described above, motion information, such as motion vectors, are used to identify the velocity 510 of the block or object represented by the block. The velocity can be represented by separate horizontal and vertical velocities, or the velocity can be represented by a two-dimensional vector or function as shown. The velocities are mapped 520 to coefficient cutoff indices. For example, for separate horizontal and vertical motion models, there can be a column cutoff index Tₓ and a row cutoff index T_{y}.

FIG. 5 shows two examples of how the cutoff indices can be used to determine the subset of coefficients which are signaled, and thus which coefficients are cut off. For the simple cutoff case 531, the values Tₓ and T_{y} are used as simple column and row indicators. Coefficients having column indices greater than Tₓ or row indices greater than T_{y} are cut off, i.e., not signaled in the bitstream. In this case, the subset of coefficients signaled in the bitstream are a Tₓ×T_{y} rectangular block of coefficients.

Another method 532 for cutting out coefficients can use a 2-D function g(Tₓ, T_{y}). This function can trace any path over a block, outside which coefficients are not signaled. Additional embodiments can relate the function g to the type of transform being used, as the spatial frequency components represented by a given coefficient position is dependent upon the type of transform being used by the codec.

The motion-based perceptual, or visual acuity model, can consider the horizontal and vertical velocities separately or jointly. As described above, cutoff indices can be determined separately based on horizontal and vertical motion, or the cutoff indices can be determined jointly as a function of the horizontal and vertical or other measured motion directions combined. For systems that apply separable transforms horizontally and vertically, the horizontal and vertical motion models and cutoff indices can also be applied in a separable fashion, both horizontally and vertically. Thus, the complexity reductions resulting from hardware and software implementations of separable transforms can also be extended to the separable application of this invention.

Encoder

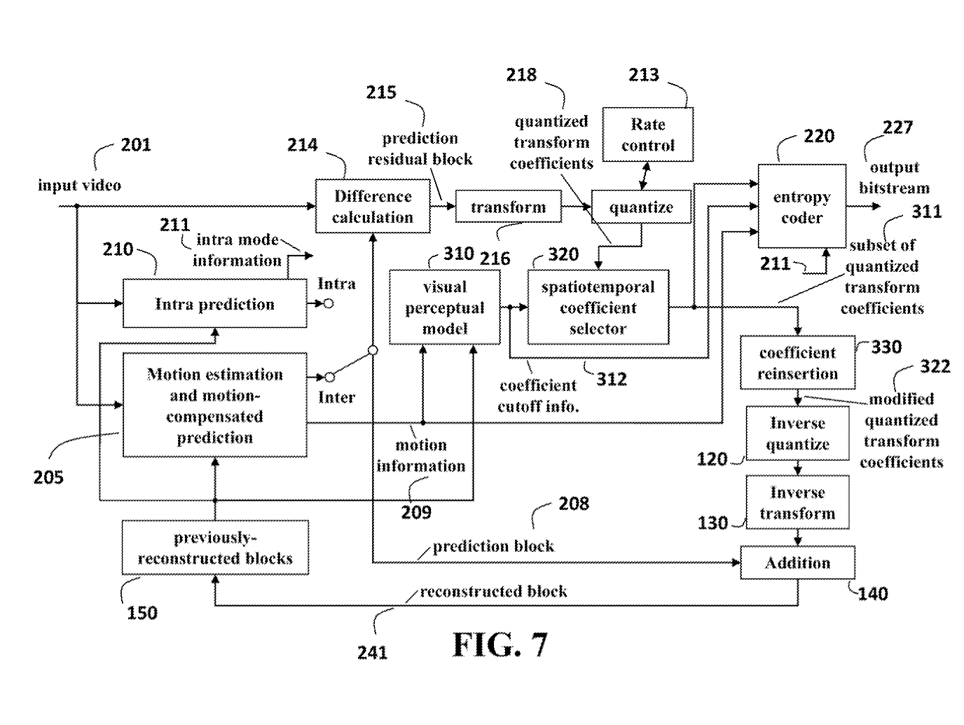

FIG. 7 shows a schematic of an encoder according to the embodiments of the invention. Blocks and signals labelled similarly are described above. An input video or a block of input video is input to the motion estimation and motion-compensated prediction process 205. The prediction portion of this process uses previously-reconstructed blocks 150, typically stored in a memory buffer, to generate a prediction block 208 corresponding to the current input video block along with motion information such as motion vectors. Alternatively, the prediction block can be determined by an intra prediction process, which also produces intra mode information. The input video block and the prediction block are input to a difference calculation 214, which outputs a prediction residual block. This prediction residual block is transformed and quantized, which produces quantized transform coefficients. The motion information, and optionally previously-reconstructed block data, is also input to the visual perceptual model, which determines coefficient cutoff information. The cutoff information is used by the spatiotemporal coefficient selector to identify a subset of quantized transform coefficients that will be signaled by an entropy coder to the bitstream. Additional mode and motion information are also signaled in the bitstream 227.

The subset of quantized transform coefficients also undergo a coefficient reinsertion process 330, in which coefficients outside the subset are assigned predetermined values, resulting in a complete set of modified quantized transform coefficients. This modified set undergoes an inverse quantization and inverse transform process, whose output is added to the prediction block to produce a reconstructed block. The reconstructed block is stored in memory for use in subsequent prediction and motion estimation processes.

### Additional Embodiments

The preferred embodiment describes how the coefficient selector and reinsertion processes are applied prior to inverse quantization in the decoder. In an additional embodiment, the coefficient selector and reinsertion processes can be applied between the inverse quantization and inverse transform. In this case, the coefficient cutoff information is also input to the inverse quantizer so that the quantizer knows which coefficients are signaled in the bitstream. Similarly, the encoder can have the coefficient selector between the transform and quantize processes (and the inverse quantization and inverse transform processes) and the coefficient selector can also be input to the quantizer (and inverse quantizer) so the quantizer knows which subset of coefficients to quantize.

The functions ƒ(mvₓ) and ƒ(mv_{y}), which map motion information to velocities, can include a scaling, another mapping, or thresholding. For example, the functions can be configured so that no coefficients are cutoff when the motion represented by mvₓ and mv_{y} is below a given threshold. The motion information input to these functions can also be scaled nonlinearly, or the motion information can be mapped based upon an experimentally predetermined relation between motion and visible frequencies. When a predetermined relation is used, the decoder and encoder use the same model, so no additional side information needs to be signaled. A further refinement of this embodiment allows the model to vary, in which additional side information is needed.

The functions ƒ(mvₓ) and (mv_{y}) and corresponding mappings and visual perceptual model can also incorporate the motion associated with neighboring previously-decoded blocks. For example, suppose a large cluster of blocks in a video has similar motion. This cluster can be associated with a large moving object. The visual perceptual model can determine that such an object can likely to be tracked by the human eye, causing the velocity of the block relative to the viewer's retina to be decreased, as compared to a small moving object that the viewer is not following. In this case, the functions ƒ(mvₓ) and ƒ(mv_{y}) and corresponding mappings can be scaled so that fewer coefficients are cut out of the block of coefficients. Conversely, if the current block has a significantly amount of motion or direction of motion as compared to neighboring blocks, then the visual perceptual model can increase the number of cut-out coefficients under the assumption that distortion is less likely to be perceived in a block that is difficult to track due to surrounding motion.

The encoder can perform additional motion analysis on the input video to determine motion and perceptible motion. If this analysis results in a change in the cut off coefficients as compared to a codec, which uses existing information such as motion vectors, then the results of the additional motion analysis can be signaled in the bitstream. The decoder's visual perceptual model and mappings can incorporate this additional analysis along with the existing motion information, such as motion vectors.

In addition to reducing the number of coefficients that are signaled, another embodiment can reduce other kinds of information. If a codec supports a set of modes, such as prediction modes or block size or block shape modes, then the size of this set of modes can be reduced based upon the visual perceptual model. For example, a codec may support several block-partitioning modes, where a 2N×2N block is partitioned into multiple 2N×N, N×2N, N×N, etc. sub-blocks. Typically, smaller block sizes are used to allow different motion vectors or prediction modes to be applied to each sub-block, resulting in a higher fidelity reconstruction of the sub-block. If the motion model, however, determines that all motion associated with a 2N×2N block is fast enough so that some spatial frequencies are unlikely to be perceptible, then the codec can disable the use of smaller sub-blocks for this block. By limiting the number of partitioning modes in this way, the complexity of the codec, and the number of bits needed to be signaled for these modes in the bitstream, can be reduced.

The perceptual model can also incorporate spatial information from neighboring previously-decoded blocks. If the current block is part of a moving or non-moving object which encompasses the current block and neighboring previously-reconstructed blocks, then the visual perceptual model and mappings for the current block can be made more similar to those used for the previously-reconstructed blocks. Thus, a consistent model is used over a moving object comprising multiple blocks.

The perceptual model and mappings can be modified based upon the global motion in the video. For example, if a video was acquired by a camera panning across a stationary scene, then the mappings can be modified to cut out no coefficients, unless this global motion is above a given threshold. Above this threshold, the panning is considered to be so fast that a viewer would be unlikely to be able to track any object in the scene. This may happen during a fast transition between scenes.

This invention can also be extended to operate on intra-coded blocks. Motion can be associated with intra-coded blocks based upon the motion of neighboring or previously-decoded and spatially-correlated inter-coded blocks. In a typical video coding system, intra-coded pictures or intra-coded blocks may occur only periodically, so that most blocks are inter-coded. If no scene-change is detected, then the parts of a moving object coded using an intra-coded block can be assumed to have motion consistent with the previously-decoded intra-coded blocks from that object. The coefficient cut-off process can be applied to the intra-coded blocks using the motion information from the neighboring or motion-consistent blocks in previously-decoded pictures. Additional reductions in signaled information can be achieved by reducing, for example, the number of prediction modes or block partitioning modes available for use by the intra-coded block.

The type of transform can be modified or selected based upon the visual perceptual model. For example, slow-moving objects can use a transform that reproduces sharp fine detail, whereas fast objects can use a transform, such as a directional transform, that reproduces detail in a given direction. If the motion of a block is, for example, mostly horizontal, then a directional transform that is oriented horizontally can be selected. The loss of vertically-oriented detail is imperceptible according to the visual model. Such directional transforms can be less complex and better performing in this case as compared to conventional two-dimensional separable transforms like the 2-D DCT.

The invention can be extended to work with stereo (3-D) video in that objects in the mappings can be scaled so that more coefficients are cut of in background objects, and fewer coefficients are cut off in foreground objects. Given that a viewer's attention is likely to be focused on the foreground objects, additional distortion can be tolerated in background objects as the motion of the background, object increases. Furthermore, two visual perceptual models can be used: one for blocks including foreground objects, and another for blocks including background objects.

If all coefficients are cut out, then no coefficients are signaled in the bitstream for a given block. In this case, the data in the bitstream can be further reduced by not signaling any header or additional information associated with representing a block of coefficients. Alternatively, if the bitstream contains a coded-block-pattern flag which is set to true if all coefficients in the block are zero, then this flag can be set when no coefficients are to be signaled.

Instead of using the visual perceptual model to limit the subset of coefficients that are signaled, the model can also be used to determine a down-sampling factor for an input video block. Blocks can be down-sampled prior to encoding and then up-sampled after decoding. Faster moving blocks can be assigned a higher down-sampling factor, based upon the motion model.

Although the invention has been described by way of examples of preferred embodiments, it is to be understood that various other adaptations and modifications can be made within the spirit and scope of the invention. Therefore, it is the object of the appended s to cover all such variations and modifications as come within the true spirit and scope of the invention.

We claim:

1. A method for decoding a picture, wherein the picture is encoded and represented by blocks in a bitstream, comprising for each block the steps of:
determining, from the bitstream, motion associated with the block;
mapping, using a model, the motion to indices indicating a subset of quantized transform coefficients to be decoded from the bitstream; and
assigning and reinserting values to the quantized transform coefficients not in the subset, wherein the steps are performed in a decoder.

2. The method of claim 1, wherein the motion includes a horizontal and vertical velocity, the model uses the horizontal and vertical velocities to determine spatial frequency thresholds, and the mapping determines indices to identify the subset of the quantized transform coefficients whose corresponding spatial frequencies are equal to or below the spatial frequency thresholds.

3. The method of claim 1, further comprising a model for mapping motion and spatial characteristics of previously-reconstructed blocks to the indices.

4. The method of claim 1, wherein the assigning and reinserting are performed after an inverse quantization.

5. The method of claim 1, wherein a modified inverse transform operates on the subset of quantized transform coefficients.

6. The method of claim 1, wherein the values are all equal to zero.

7. The method of claim 1, wherein the values minimize differences between spatial frequency content of the block and spatial frequency content of adjacent previously-reconstructed blocks.

8. The method of claim 2, wherein the motion includes the horizontal and vertical velocities of previously-reconstructed blocks, and the model uses the velocities of the block and the velocities of previously-reconstructed blocks to determine the spatial frequency thresholds.

9. The method of claim 8, wherein the motion is a difference between the motion in the block and the motion of one or more adjacent previously-reconstructed blocks.

10. The method of claim 1, further comprising:
determining a motion threshold; and
including, in the subset, the coefficients associated with the indices resulting from when the determined motion is below the threshold.

11. The method of claim 1, wherein the model is a visual perceptual model.

12. The method of claim 1, further comprising:
decoding from the bitstream motion vectors associated with the block;
decoding from the bitstream additional motion information;
mapping, using the model, the decoded motion vectors and the additional motion information to the indices indicating the subset; and
assigning and reinserting values to the quantized transform coefficients not in the subset.

13. The method of claim 5, wherein the block is inverse transformed using a directional transform, whose direction corresponds to a direction of motion determined by the model.

14. The method of claim 1, the models includes a model for foreground objects, and a model for background objects.

15. The method of claim 1, wherein the motion associated with an intra-coded block is determined from motion of spatially and temporally-neighboring previously-decoded blocks.

16. The method of claim 1, wherein a set of available block partitioning modes is reduced based on the model.

17. The method of claim 15, wherein a set of intra prediction modes is reduced based on the model.

18. The method of claim 1, wherein the model relates the motion to a spatial frequency threshold that decreases as motion increases, and content of the block with the spatial frequencies higher than the spatial frequency threshold is imperceptible, and further comprising:
signaling only the coefficients associated with spatial frequencies below the spatial frequency threshold in the bitstream.

19. A method for encoding a picture as blocks in a bitstream, comprising fobr each block the steps of:
determining motion associated with the block;
mapping, using a model, the motion to indices indicating a subset of quantized transform coefficients to be signaled in the bitstream; and
assigning and reinserting values to the quantized transform coefficients not in the subset, wherein the steps are performed in an encoder.

20. The method of claim 19, further comprising:
determining motion vectors associated with the block;
determining additional motion information based on content of the block; and
entropy coding and signaling the motion vectors and the additional motion information in the bitstream.
